(19) United States
(12) Patent Application Publication
(10) Pub. No.: US 2019/0233311 A1
(43) Pub. Date: Aug. 1, 2019

(54) Advanced Ozogation Apparatus and Process

(71) Applicant: Ernie Wilmink, Burnet, TX (US)

(72) Inventor: Ernie Wilmink, Burnet, TX (US)

(21) Appl. No.: 16/264,029

(22) Filed: Jan. 31, 2019

Related U.S. Application Data
(60) Provisional application No. 62/624,683, filed on Jan. 31, 2018.

(51) Int. Cl. C02F 1/467; C02F 1/32; C01B 13/11; A01G 7/06; A01G 25/09

(52) U.S. Cl. CPC C02F 1/4672; C02F 1/32; C02F 2103/32; A01G 7/06; A01G 25/09; C01B 13/11

(57) ABSTRACT

An advanced ozogation apparatus includes an ozone generator subsystem configured to generate ozone from ambient air. The advanced ozogation apparatus includes an advanced oxidation subsystem. The advanced oxidation subsystem includes a venturi assembly configured to generate ozonated water by combining water and the generated gaseous ozone. The advanced oxidation subsystem includes an ultraviolet reactor configured to induce hydroxyl radicals within the ozonated water. The advanced oxidation subsystem includes a retention tank configured to store the hydroxyl radical-induced ozonated water. The retention tank is configured to receive the hydroxyl radical-induced ozonated water via a mass transfer subsystem. The advanced ozogation apparatus includes a disperser configured to disperse the hydroxyl radical-induced ozonated water to one or more plants. The retention tank is configured to output the hydroxyl radical-induced ozonated water to the disperser.

### CROSS-REFERENCE TO RELATED APPLICATIONS

The present application claims the benefit under 35 U.S.C. § 119(e) of U.S. Provisional Patent Application Ser. No. 62/624,683, filed Jan. 31, 2018, entitled ADVANCED OXIDATION PROCESS AND OZOGATION TECHNOLOGY, naming Ernie Wilmink as inventor, which is incorporated herein by reference in the entirety.

### TECHNICAL FIELD

The present invention generally relates to applications requiring ozonated water and, in particular, to an advanced ozogation apparatus and process.

### BACKGROUND

Disinfection of plants (e.g., vines, bushes, trees, or the like) to control and/or prevent disease is essential to boosting fruits and vegetables grown by the plants. One method of disinfection is the process of “chemigation,” or the use of pesticides, insecticides, fungicides, and/or other chemicals to destroy bacteria that may potentially cause disease in the crops.

Chemigation, however, may adversely impact the health of the plants and/or affect the fruits and vegetables grown by the plants. For example, residue may remain on grapes sprayed during chemigation processes, which may ultimately contaminate a wine produced from the grapes. For instance, the contamination of the wine may affect the environment in which the grapes are stored (e.g., a wine barrel, such as during fermentation), affect the taste and/or flavors of the wine, and/or provide a consumer with the chemicals through ingestion of the wine.

In addition, chemigation may impact secondary biosystems outside of the immediate biosystems in which the plants are grown. For example, the chemicals may leach into water sources via irrigation run-off, contaminating water sources for animals who directly or indirectly interact with the water sources. For instance, the animals may be provided with the chemicals via the ingestion of the contaminated water. In addition, animals may be provided with the chemicals via the ingestion of plants and/or animals that live in and/or ingest the water themselves.

Therefore, it would be advantageous to provide an apparatus and process that cures the shortcomings described above.

### SUMMARY

An advanced ozogation apparatus is disclosed, in accordance with one or more embodiments of the present disclosure. In one embodiment, the advanced ozogation apparatus includes an ozone generator subsystem configured to generate ozone from ambient air. In another embodiment, the advanced ozogation apparatus includes an advanced oxidation subsystem. In another embodiment, the advanced oxidation subsystem includes a venturi assembly configured to generate ozonated water by combining water and the generated gaseous ozone. In another embodiment, the advanced oxidation subsystem includes an ultraviolet reactor configured to induce hydroxyl radicals within the ozonated water. In another embodiment, the advanced oxidation subsystem includes a retention tank configured to store the hydroxyl radical-induced ozonated water. In another embodiment, the retention tank is configured to receive the hydroxyl radical-induced ozonated water via a mass transfer subsystem. In another embodiment, the advanced ozogation apparatus includes a disperser configured to disperse the hydroxyl radical-induced ozonated water to one or more plants. In another embodiment, the retention tank is configured to output the hydroxyl radical-induced ozonated water to the disperser.

An advanced oxidation subsystem for an advanced ozogation apparatus is disclosed, in accordance with one or more embodiments of the present disclosure. In one embodiment, the advanced oxidation subsystem for the advanced oxidation apparatus includes an ultraviolet reactor configured to induce hydroxyl radicals within ozonated water generated from gaseous ozone and water. In another embodiment, the advanced oxidation subsystem for the advanced oxidation apparatus includes a retention tank configured to store the hydroxyl radical-induced ozonated water. In another embodiment, the retention tank is configured to receive the hydroxyl radical-induced ozonated water via a mass transfer subsystem. In another embodiment, the hydroxyl radical-induced ozonated water is dispersed to one or more plants.

A method is disclosed, in accordance with one or more embodiments of the present disclosure. In one embodiment, the method may include, but is not limited to, generating gaseous ozone from ambient air via an ozone generator. In one embodiment, the method may include, but is not limited to, generating ozonated water by combining water and the generated gaseous ozone. In one embodiment, the method may include, but is not limited to, inducing hydroxyl radicals within the ozonated water via an ultraviolet reactor. In one embodiment, the method may include, but is not limited to, dispersing at least a portion of the hydroxyl-radical induced ozonated water to one or more plants via a disperser.

### BRIEF DESCRIPTION OF THE DRAWINGS

The numerous advantages of the present disclosure may be better understood by those skilled in the art by reference to the accompanying figures in which:

FIG. 1A illustrates a simplified block diagram of an environment including an advanced ozogation apparatus, in accordance with one or more embodiments of the present disclosure;

FIG. 1B illustrates a simplified block diagram of an environment for an advanced ozogation apparatus, in accordance with one or more embodiments of the present disclosure;

FIG. 2 illustrates a simplified block diagram of an advanced ozogation apparatus, in accordance with one or more embodiments of the present disclosure;

FIG. 3 illustrates a simplified diagram of an ozone generator subsystem for an advanced ozogation apparatus, in accordance with one or more embodiments of the present disclosure;

FIG. 4 illustrates a simplified block diagram of an advanced oxidation subsystem for an advanced ozogation apparatus, in accordance with one or more embodiments of the present disclosure;

FIG. 5A illustrates a trailer including an advanced ozogation apparatus, in accordance with one or more embodiments of the present disclosure;

FIG. 5B illustrates a trailer including an advanced ozogation apparatus, in accordance with one or more embodiments of the present disclosure; and

FIG. 6 illustrates a flow diagram of a method for an advanced ozogation process, in accordance with one or more embodiments of the present disclosure.

### DETAILED DESCRIPTION OF THE INVENTION

Reference will now be made in detail to the subject matter disclosed, which is illustrated in the accompanying drawings.

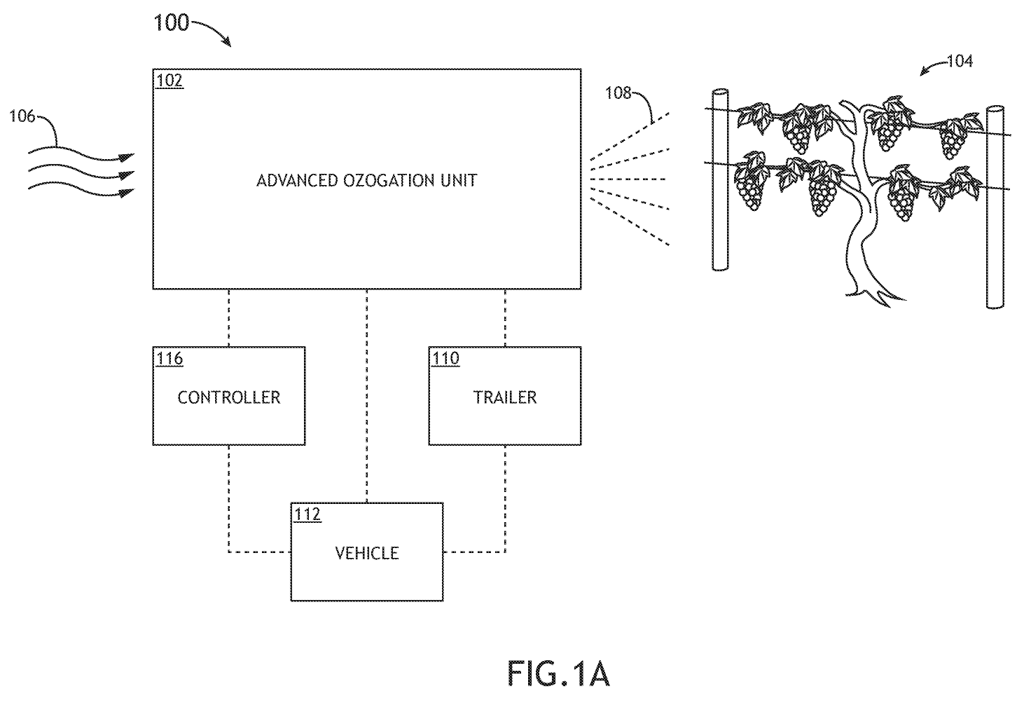

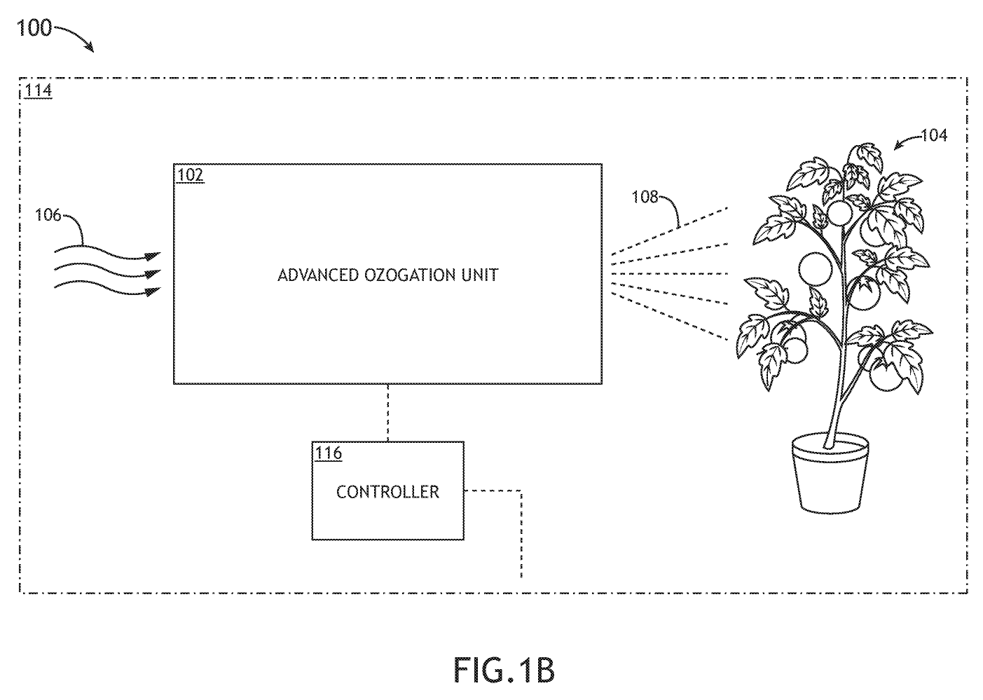

Referring generally to FIGS. 1A-6, an advanced ozogation apparatus and process is disclosed, in accordance with one or more embodiments of the present disclosure.

Embodiments of the present disclosure are directed to an advanced ozogation apparatus and process. Embodiments of the present disclosure are also directed to generating ozone, generating ozonated water, and increasing the reactivity of the ozonated water by inducing hydroxyl radicals. Embodiments of the present disclosure are also directed to dispersing the ozonated water on plants at a select oxidation-reduction-potential (ORP) level.

FIGS. 1A and 1B generally illustrate a simplified block diagram of an environment 100 including an advanced ozogation apparatus, in accordance with one or more embodiments of the present disclosure.

In one embodiment, the environment 100 includes an advanced ozogation apparatus 102. In another embodiment, the advanced ozogation apparatus 102 is implemented within a greenhouse, field, orchard, vineyard, or other location for growing plants 104 (e.g., vines, bushes, trees, or the like). In another embodiment, the advanced ozogation apparatus 102 collects ambient air 106. In another embodiment, the advanced ozogation apparatus 102 outputs ozonated water droplets 108 onto the plants 104.

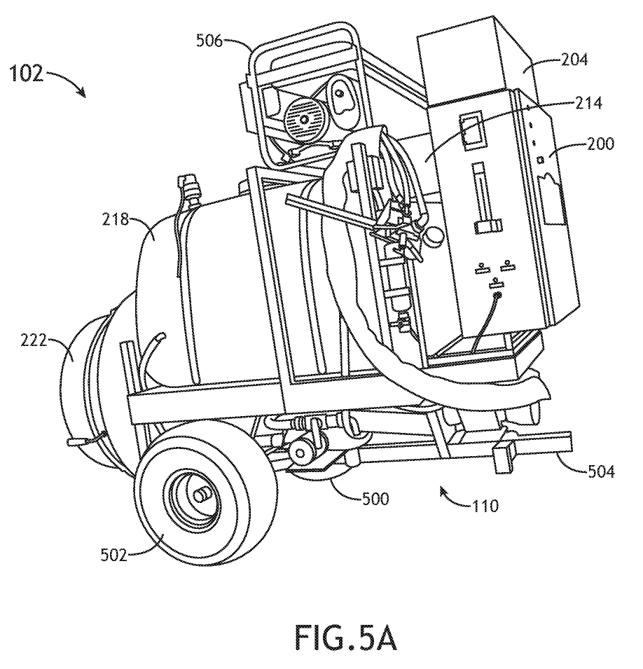

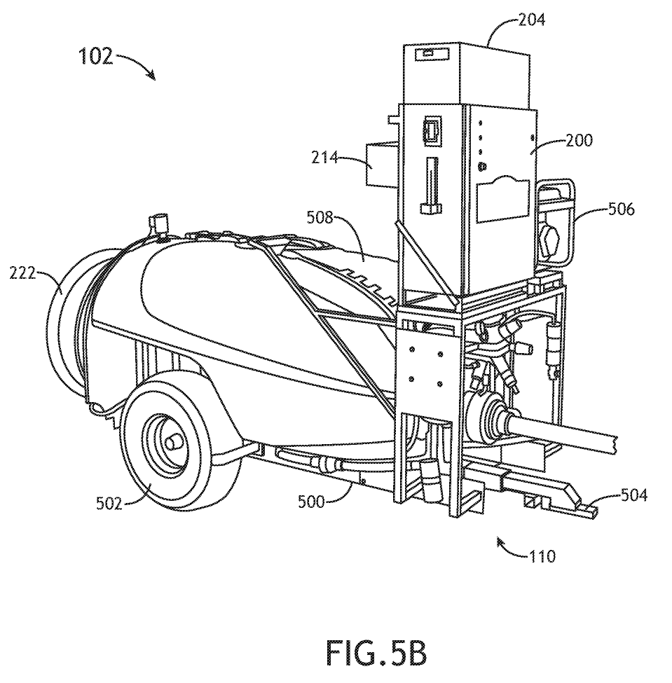

In another embodiment, the advanced ozogation apparatus 102 is moveable. For example, as illustrated in FIGS. 5A and 5B, the advanced ozogation apparatus 102 may be mounted to a trailer 110 towed by a vehicle 112 (e.g., a tractor, a truck, an all-terrain vehicle (ATV), a side-by-side such as a utility vehicle (UTV), or the like). By way of another example, the advanced ozogation apparatus 102 may be mounted to any of the vehicle 112, a helicopter, an airplane (e.g., cropduster), an unmanned aerial vehicle (e.g., drone), a push cart, or the like.

In another embodiment, the advanced ozogation apparatus 102 is fixed in place in a physical location 114. For example, as illustrated in FIG. 1B, the physical location 114 may include, but is not limited to, a greenhouse, field, orchard, vineyard, or other location for growing the plants 104. For instance, the advanced ozogation apparatus 102 may be mounted within a greenhouse on a fixed scaffolding, tower, or girder, on a conveyor assembly, or the like. By way of another example, the physical location 114 may include a grocery store (e.g., the produce section of the grocery store).

In another embodiment, the environment 100 includes a controller 116. For example, the controller 116 may be coupled to and/or in communication with one or more of the trailer 110, the vehicle 112, the physical location 114, or the like via one or more wireline and/or wireless portions. In another embodiment, the controller 116 includes one or more processors and memory. In another embodiment, the memory stores one or more set of program instructions. In another embodiment, a user interface is communicatively coupled to and/or integrated with the controller 116. In another embodiment, the user interface includes one or more display devices and/or one or more user input devices. In another embodiment, the one or more display devices are coupled to the one or more user input devices by a transmission medium that includes one or more wireline and/or wireless portions.

Although embodiments of the present disclosure illustrate the controller 116 as a stand-alone component from the one or more of the trailer 110, the vehicle 112, the physical location 114, it is noted herein that the controller 116 may be integrated within any of the one or more of the trailer 110, the vehicle 112, or the physical location 114. Therefore, the above description should not be interpreted as a limitation on the scope of the present disclosure but merely an illustration.

Although embodiments of the present disclosure describe the controller 116 as a component of the environment 100, it is noted herein that the controller 116 may not be an integral or required component of the environment 100. Therefore, the above description should not be interpreted as a limitation on the scope of the present disclosure but merely an illustration.

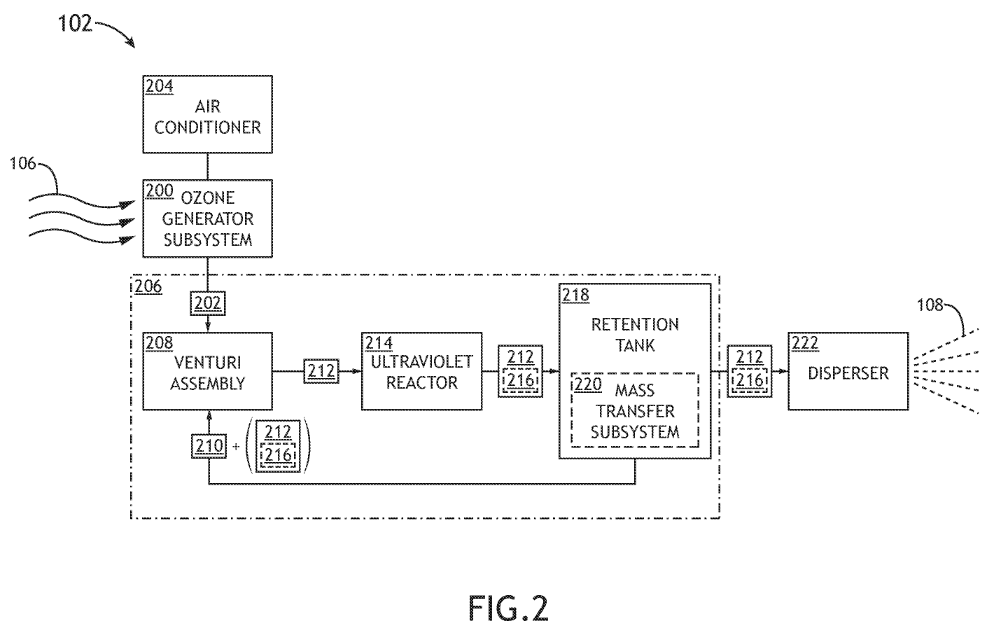

FIGS. 2-4 generally illustrate the advanced ozogation apparatus 102 and components thereof, in accordance with one or more embodiments of the present disclosure.

In one embodiment, the advanced ozogation apparatus 102 includes an ozone generator subsystem 200. In another embodiment, the ozone generator subsystem 200 is configured to generate gaseous ozone 202. It is noted herein that ozone (03) is an unstable, highly-reactive gas generated through the decomposition of oxygen (O₂) gas. In addition, it is noted herein gaseous ozone is approved by United States federal agencies (e.g., including the United States Department of Agriculture (USDA) and the United States Food and Drug Administration (FDA)) as a food contact substance for the preservation and disinfection of select food products and food by-products, without the requiring of a pesticide label. For example, gaseous ozone is usable as a preservative for select foods, including grapes.

It is noted herein that, unlike chemicals, gaseous ozone becomes oxygen gas either after it is used to remove contaminants/impurities and/or through the normal course of degradation. In addition, it is noted herein that gaseous ozone becomes oxygen gas without leaving harmful by-products in the water.

In one example, the cellular lysing caused by the microbacterial deactivation caused by the gaseous ozone 202 may help prevent contamination in the wine industry by promoting a sterile and clean environment. For example, cross-contamination between wine batches may be reduced. By way of another example, the management of the active yeast strain necessary for fermentation versus non-desired yeast strains (e.g., Brettanomyces, which may contaminate a finished wine product and introduce undesired flavor profiles) may be made easier through disinfecting with gaseous ozone 202.

In this example, gaseous ozone 202 may be implemented to disinfect the vineyard while the grapes are still on the line and/or may be implemented to disinfect wine barrels prior to filling. It is noted herein that, unlike chlorine or many other chemicals, ozone will not leach into the wine barrel oak wood, preventing environment contamination. In addition, it is noted herein that the gaseous ozone 202 as a disinfectant may prevent a buildup of trichloroanisole (TCA), which is a leading factor in cork tainting.

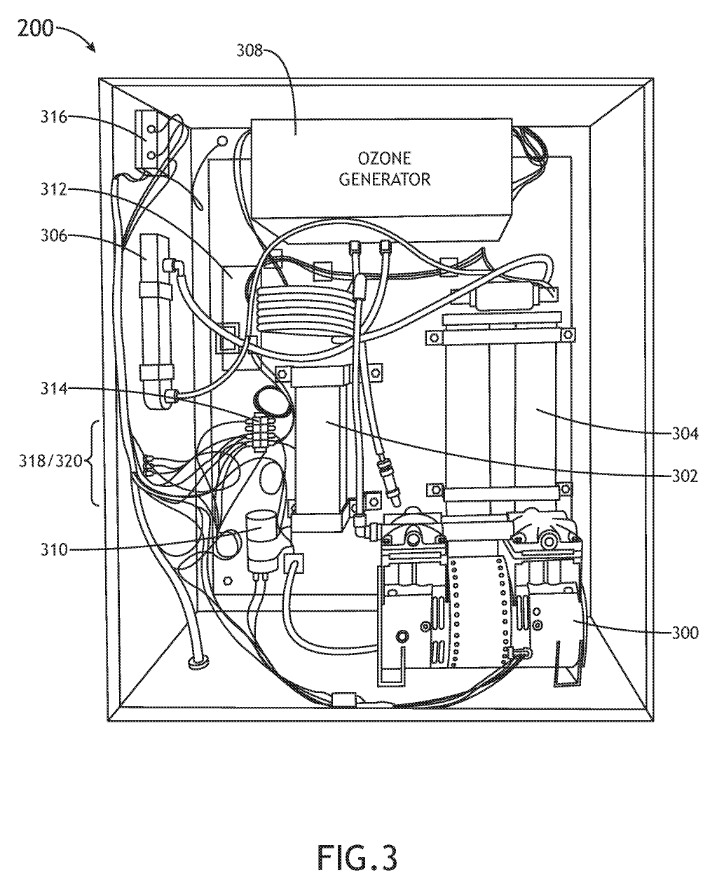

Referring now to FIG. 3, in one embodiment, the ozone generator subsystem 200 receives ambient air 106 via an air compressor 300. It is noted herein that the ambient air 106 may pass through one or more air cleaning intake filters prior to entering the air compressor 300.

In another embodiment, the ambient air 106 is dried to a select dew point temperature via an air dryer 302. By way of another example, the select dew point temperature may be at least −80 degrees Fahrenheit (° F.). For instance, the select dew point temperature may be −100° F. It is noted herein that drying the ambient air 106 removes humidity and/or moisture from the ambient air 106.

In another embodiment, oxygen (O₂) gas is generated via an oxygen generator or concentrator 304. For example, the oxygen gas may be sourced from the ambient air 106, which is comprised of approximately 78 percent nitrogen (N₂) gas, approximately 21 percent oxygen (O₂) gas, and approximately 1 percent other various gases. By way of another example, the oxygen concentrator 304 may implement pressure swing adsorption (PSA) technology. For instance, the pressure swing adsorption (PSA) technology may utilize Zeolite to absorb the nitrogen gas. It is noted herein that removing the nitrogen gas may effectively remove any nitrogen oxide (NO₂) and/or Nitric Acid (HNO₃) by-product.

In another embodiment, the oxygen gas is passed through an instrument gauge 306. The instrument gauge 306 may be any analog or digital gauge configured to display a parameter of the oxygen gas. For example, the instrument gauge 306 may include a pressure gauge configured to display the oxygen gas pressure within the ozone generator subsystem 200 piping. By way of another example, the instrument gauge 306 may include a gauge configured to display the oxygen gas temperature, dew point, humidity, or the like within the ozone generator subsystem 200 piping. In another embodiment, the read-out (e.g., analog or digital) of the instrument gauge 306 may be visible (e.g., passed through a hole or positioned behind a transparent plate or hole) by an individual standing proximate to the ozone generator subsystem 200.

In another embodiment, the oxygen gas is processed to generate the gaseous ozone 202 via an ozone generator 308. For example, the dried oxygen gas may be excited with electricity (e.g., via pulse width modulation), and the energy provided through electrical excitation may separate the oxygen gas molecules into oxygen atoms. The gaseous ozone 202 may be generated via any ozone generator 308 known in the art. For example, the ozone generator 308 may include a variable output plasma block ozone generator (e.g., a corona discharge ozone generator). It is noted herein, however, that the ozone generator 308 may include an ultraviolet (UV) ozone generator. In one example, the ozone generator 308 may produce up to 50 grams/hour (g/h) of gaseous ozone 202 at 5 percent weight.

In another embodiment, the ozone generator subsystem 200 includes one or more internal electrical components configured to operate and allow for electrical coupling between one or more of the air compressor 300, air dryer 302, instrument gauge 306, and/or the ozone generator 308. For example, the one or more internal electrical components may include a start-up capacitor 310 (e.g., coupled to the air compressor 300), one or more timerboards 312 (e.g., coupled to the oxygen concentrator 304), one or more terminal blocks 314, a ground-fault circuit interrupter (GFCI) 316 coupled to an external power cord, one or more indicators 318 (e.g., colored lights, sound generators, digital or analog read-outs, or the like), one or more toggles 320 (e.g., buttons or switches), one or more fuses, wiring, or the like.

In another embodiment, the components of the ozone generator subsystem 200 are housed within a cavity defined by a body or chassis. In another embodiment, the body or chassis has a lid or cover (e.g., as illustrated in FIGS. 5A and 5B). For example, the lid or cover may be slid on, snapped on, hinged to the body or chassis, or the like. By way of another example, the one or more indicators 318 and/or the one or more toggles 320 may pass through the lid or cover instead of through a wall of the body or chassis. It is noted herein, however, that the components of the ozone generator subsystem 200 may be exposed (e.g., to the environment 100).

It is noted herein the ozone generator subsystem 200 may be compliant with federal and/or state agency (e.g., the Environmental Protection Agency (EPA), or the like) regulations.

Referring again to FIG. 2, in one embodiment the ozone generator subsystem 200 is maintained at a select temperature via an air conditioner 204. For example, the ozone generator subsystem 200 may produce heat and may need to be kept cool through heat removal via one or more air-cooling or water-cooling methods. For example, the ozone generator subsystem 200 may be maintained at a select air conditioning temperature ranging from 50 to 100 degrees Fahrenheit (° F.). For instance, the select air conditioning temperature may be 72° F. In another embodiment, the air conditioner 204 is coupled to the internal electrical components of the ozone generator subsystem 200 to allow for communication between the air conditioner 204 and the ozone generator subsystem 200. For example, the air conditioner 204 may be coupled via a quick-connect plug configured to couple to a terminal installed within a wall of the body or chassis of the ozone generator subsystem 200.

In another embodiment, the advanced ozogation apparatus 102 includes an advanced oxidation subsystem 206, or advanced oxidation process (AOP) subsystem 206. In another embodiment, the advanced oxidation subsystem 206 includes a venturi assembly 208. In another embodiment, the venturi assembly 208 is configured to receive the gaseous ozone 202 generated by the ozone generator subsystem 200. In another embodiment, the venturi assembly 208 is configured to receive water 210 from a retention tank (e.g., a retention tank 218). It is noted herein that gaseous ozone is only partially soluble in water. For example, the equilibrium ozone water solubility at 41° F. water temperature and 3 percent ozone weight is 22.18 milligrams/liter (mg/I). In this regard, using water as a carrier fluid for gaseous ozone provides natural protection from over-ozogation.

In another embodiment, the venturi assembly 208 is configured to generate ozonated water 212 (e.g., ozonated water, aqueous ozone, oxygenated water, or the like) by mixing the gaseous ozone 202 and the water 210 (e.g., via an ozogation process, or the process of infusing gaseous ozone into water).

In another embodiment, the advanced oxidation subsystem 206 includes an ultraviolet (UV) reactor 214 configured to generate or induce hydroxyl radicals (OH⁻ ions) within the ozonated water 212. In another embodiment, the advanced oxidation subsystem 206 includes the retention tank 218 configured to receive and store the ozonated water 212 with the hydroxyl radicals 216.

In another embodiment, the retention tank 218 includes a mass transfer subsystem 220. It is noted herein that the fluid flow and storage of the ozonated water 212 with the hydroxyl radicals 216 may need to be closely regulated by the mass transfer subsystem 220, due to the short half-life of gaseous ozone in water. In another embodiment, the turnover rate of the mass transfer subsystem 220 is a select rate dependent on the half-life of the gaseous ozone infused within water. For example, the half-life of the gaseous ozone in water is approximately twenty-five minutes. In this example, the turnover rate for the mass transfer subsystem 220 may be approximately fifteen minutes.

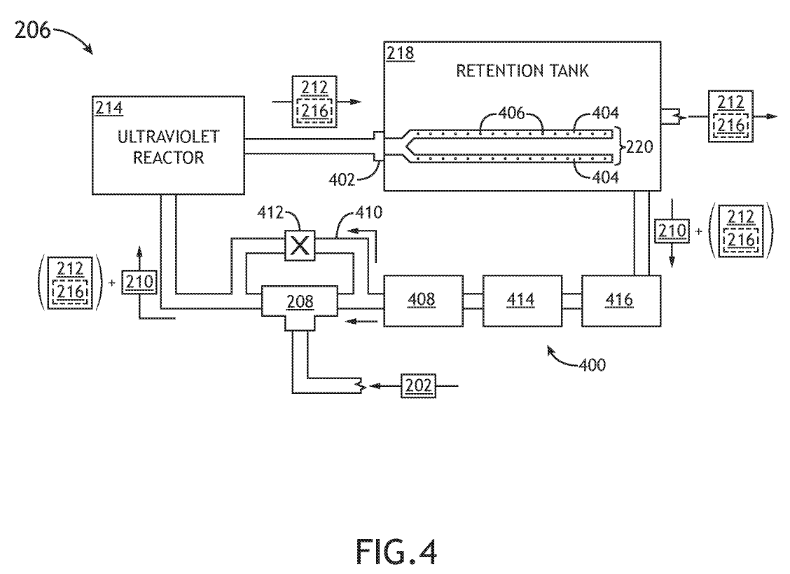

Referring now to FIG. 4, in one embodiment the advanced oxidation subsystem 206 includes a fluid flow loop 400. In another embodiment, the fluid flow loop 400 couples the venturi assembly 208 and the retention tank 218. In another embodiment, the venturi assembly 208 receives the gaseous ozone 202 from the ozone generator subsystem 200) and the water 210 from the retention tank 218. In another embodiment, the venturi assembly 208 combines the gaseous ozone 202 and the water 210 to generate the ozonated water 212.

In another embodiment, the UV reactor 214 receives the ozonated water 212 from the venturi assembly 208. In another embodiment, the UV reactor 214 is configured to generate hydroxyl radicals 216 (e.g., OH⁻ ions) within the ozonated water 212 to increase the reduction-oxidation (redox) potential, or oxidation-reduction-potential (ORP). For example, the UV reactor 214 may apply a UV dose of 40 millijoules per square centimeter (mJ/cm²), or the certified flow rate at 70 percent UV transmittance required for an NSF 55 (National Sanitation Foundation) Class A certification. It is noted herein that a dose is equal to a select intensity for a select period of time, or Dose=Intensity×Time, for purposes of the present disclosure.

In another embodiment, the retention tank 218 is configured to receive the ozonated water 212 including the hydroxyl radicals 216 via the mass transfer subsystem 220. In another embodiment, the mass transfer subsystem 220 includes a manifold 402 coupled to and/or configured to pass through a wall of the retention tank 218.

In another embodiment, the mass transfer subsystem 220 includes one or more pipes or tubes 404 coupled to the manifold 402. In another embodiment, at least some of the pipes or tubes 404 include a set of holes or openings 406. For example, the at least some of the pipes or tubes 404 may be perforated. In another embodiment, at least some of the one or more pipes 404 are weighted. For example, at least some of the one or more pipes 404 may be positioned/located at the bottom of cavity defined within the retention tank 218 via one or more weights. It is noted herein that at least some of the pipes or tubes 404 may pass through the wall of the retention tank 218, such that the mass transfer subsystem 220 does not require the manifold 402. Therefore, the above description should not be interpreted as a limitation on the scope of the present disclosure, but merely an illustration.

In one embodiment, the advanced oxidation subsystem 206 includes a circulating pump 408. In another embodiment, the circulating pump 408 is configured to initially circulate the water 210. In another embodiment, the circulating pump 408 is configured to subsequently circulate at least some of the ozonated water 212 including the hydroxyl radicals 216 through the venturi assembly 208. In another embodiment, the advanced oxidation subsystem 206 includes a secondary line 410 between the circulating pump 408 and the UV reactor 214. In another embodiment, the secondary line 410 includes one or more fluid flow components 412 (e.g., analog or digital valves, gauges, or the like). For example, the secondary line 410 may operate in addition to or instead of the line between the circulating pump 408 and the venturi assembly 208.

In another embodiment, the advanced oxidation subsystem 206 includes a check valve 414 between the retention tank 218 and the circulating pump 408. In another embodiment, the advanced oxidation subsystem 206 includes a filter 416 between the retention tank 218 and the circulating pump 408.

In another embodiment, the fluid flow loop 400 includes one or more of the circulating pump 408, the secondary line 410, the check valve 414, and/or the filter 416). It is noted herein, however, that one or more of the secondary line 410, the check valve 414, and/or the filter 416 may be optional within the advanced oxidation subsystem 206. In addition, it is noted herein that the order of the components within the advanced oxidizer subsystem 206 may be re-arranged from that illustrated within FIG. 4. Therefore, the above description should not be interpreted as a limitation on the scope of the present disclosure, but merely an illustration.

Although embodiments of the present disclosure include the water 210 and the ozonated water 212 including the hydroxyl radicals 216 being stored within the same retention tank 218, it is noted herein that the water 210 and the ozonated water 212 including the hydroxyl radicals 216 may be stored in separate retention tanks 218 of the advanced ozogation apparatus 102. In addition, it is noted herein that the water 210 may be received directly from water lines instead of indirectly (e.g., the retention tank 218 first being filled from the water line). However, it is contemplated that separate retention tanks 218 or direct receiving of the water 210 from water lines may prevent the circulation of the ozonated water 212 including the hydroxyl radicals 216 through the advanced oxidation subsystem 206 and/or prevent mobility of the advanced ozogation apparatus 102. Therefore, the above description should not be interpreted as a limitation on the scope of the present disclosure, but merely an illustration.

Referring again to FIG. 2, in one embodiment the advanced ozogation apparatus 102 includes a disperser 222. In another embodiment, the retention tank 218 is configured to output the ozonated water 212 including the hydroxyl radicals 216 to the disperser 222. In another embodiment, the disperser 222 is configured to separate the ozonated water 212 including the hydroxyl radicals 216 into the ozonated water droplets 108 for application onto the one or more plants 104.

In another embodiment, the disperser 222 outputs the ozonated water droplets 108 to the plants 104. In another embodiment, the disperser 222 includes one or more fluid flow components (e.g., adjustable or fixed manifolds, nozzles, sprayers, misters, or the like) configured to output the ozonated water droplets 108 to the plants 104. In another embodiment, the disperser 222 includes one or more air flow components (e.g., fans, or the like) configured to increase the range of dispersion of the ozonated water droplets 108.

In another embodiment, the ozonated water droplets 108 are applied to the plants 104 at a select oxidation-reduction-potential (ORP, or Redox) voltage level in any environment in which the plants 104 are growing and at any dispersion stage. It is noted herein that ORP may be a measure of the cleanliness of ozonated water, and the ozonated water's ability to break down contaminants (e.g., organics including, but not limited to, microbes (e.g., coliform bacteria), mold, mildew, or other carbon-based contaminants). In addition, it is noted herein that ORP levels may be considered as a comparison between ORP level and number of contaminants in the ozonated water.

Generally, the higher the ORP level, the fewer the number of contaminants in the ozonated water 212. For example, contaminants may result in lower levels of dissolved gaseous ozone 202 in the ozonated water 212, as the contaminants are instead consuming the gaseous ozone 202. Thus, the higher the ORP level, the higher the ability of the ozonated water 212 to remove foreign contaminants.

It is noted herein that ORP may be measured via an ORP meter including a probe or electrode. The probe or electrode may be fabricated from and/or coated with platinum or gold and, when inserted into a solution with an oxidizer (e.g., ozonated water 212), may reversibly lose electrons to the oxidizer and subsequently generate a voltage. The voltage generated by this exchange may be compared to a standard or reference solution (e.g., including, but not limited to, a probe or electrode fabricated from and/or coated with silver inserted within a silver salt solution). Generally, the higher the oxidizer percentage, the higher the voltage difference between the solution with the oxidizer (e.g., ozonated water 212) and the standard or reference solution.

In addition, it is noted herein that ozone is an oxidizer, for which a positive select ORP voltage level is desired. For example, the select ORP voltage level may range from 500 millivolts (mV) to 1000 mV. For instance, the select ORP voltage level may be at least 750 mV at the plants 104 in any environment in which the plants 104 are growing and at any dispersion stage.

In another embodiment, the ORP level in the tank does not equal the ORP level on the plants 104. For example, the disperser 222 may cut the ozonated water droplets 108, which may result in a loss of gaseous ozone 202 from the ozonated water droplets 108.

It is noted herein that, while adjusting components of the disperser 222 (e.g., the nozzles) may result in less ORP voltage level loss, an increased ORP level within the retention tank 218 may translate to the select ORP voltage level being at least 750 mV at the plants 104. For example, the treating of the gaseous ozone 202 within the advanced oxidation subsystem 206 may increase the ORP voltage level of the ozonated water 212. For example, the ORP voltage level of the ozonated water may increase to at least 900 mV to ensure the select ORP voltage level being at least 750 mV at the plants 104. For instance, the ORP voltage level may increase to between 920 and 930 mV to ensure the select ORP voltage level being at least 750 mV at the plants 104.

FIGS. 5A and 5B generally illustrate the trailer 110 including the advanced ozogation apparatus 102, in accordance with one or more embodiments of the present disclosure.

In one embodiment, the advanced ozogation apparatus 102 is coupled to the trailer 110. In another embodiment, the trailer 110 includes a frame 500 and one or more sets of wheels 502. In another embodiment, the trailer 110 include a tow point 504 coupled to the frame 500.

In another embodiment, the trailer 110 includes a generator 506 configured to provide power to one or more components of the advanced ozogation apparatus 102. For example, the generator may include, but is not limited to, a gas-powered generator. It is noted herein, however, that the one or more components of the advanced ozogation apparatus 102 may receive power through trailer connectors between the towing vehicle 112 and the trailer 110. Therefore, the above description should not be interpreted as a limitation on the scope of the present disclosure, but merely an illustration.

In another embodiment, each component of the advanced ozogation apparatus 102 is coupled to the trailer 110 and/or to other components of the advanced ozogation apparatus 102. For example, the ozone generator subsystem 200, the retention tank 218, and/or the disperser 222 may be coupled to the trailer 110. By way of another example, the air conditioner 204 and the UV reactor 214 may be coupled to a surface (e.g., a wall/side surface, a back surface, a top surface, or the like) of the ozone generator subsystem 200. For instance, the UV reactor 214 may be coupled via an attachment frame to the back surface of the ozone generator subsystem 200.

In another embodiment, as illustrated in FIG. 5A, one or more components of the advanced ozogation apparatus 102 are exposed to the surrounding environment. In another embodiment, as illustrated in FIG. 5B, one or more components of the advanced ozogation apparatus 102 are protected from the surrounding environment by a cover 508. For example, the cover 508 may include one or more pre-formed body panels. By way of another example, the cover 508 may be a pre-formed, stretch-fit, or loose flexible cover (e.g., tarp, or the like).

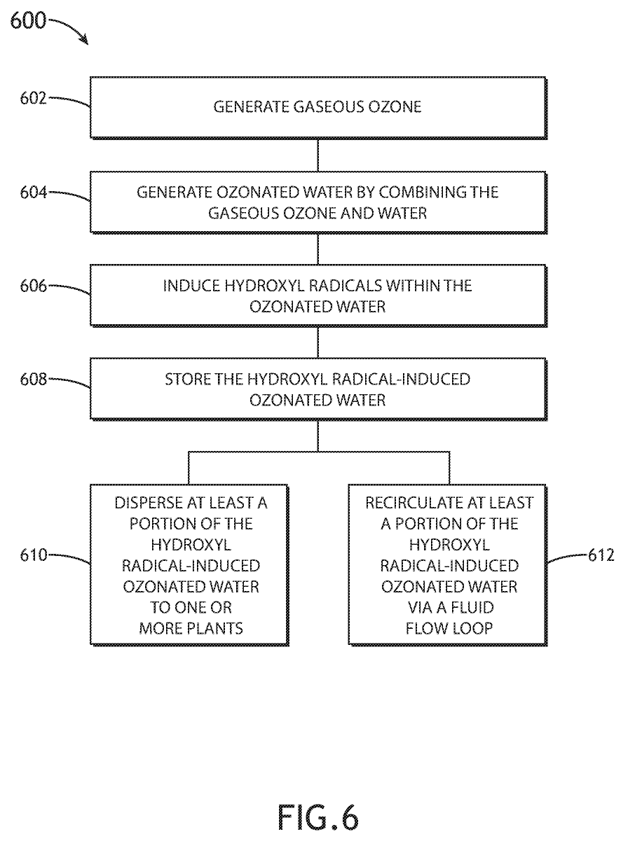

FIG. 6 illustrates a method 600 for an advanced ozogation process, in accordance with one or more embodiments of the present disclosure.

In a step 602, gaseous ozone is generated. In one embodiment, the gaseous ozone 202 is generated via the ozone generator subsystem 200 from ambient air 106 (e.g., as illustrated in FIGS. 2 and 3).

In a step 604, ozonated water is generated by combining the generated gaseous ozone and water. In one embodiment, the ozonated water 212 is generated by combining the generated gaseous ozone 202 and the water 210 via the venturi assembly 208 (e.g., as illustrated in FIGS. 2 and 4).

In a step 606, hydroxyl radicals are induced or generated within the ozonated water. In one embodiment, the hydroxyl radicals 216 are induced or generated within the ozonated water 212 via the ultraviolet reactor 214 (e.g., as illustrated in FIGS. 2 and 4).

In a step 608, the hydroxyl radical-induced ozonated water is stored. In one embodiment, the retention tank 218 is configured to receive the ozonated water 212 induced with the hydroxyl radicals 216 via a mass transfer subsystem 220 (e.g., as illustrated in FIGS. 2 and 4).

In a step 610, at least a portion of the hydroxyl radical-induced ozonated water is dispersed to one or more plants. In one embodiment, at least a portion of the ozonated water 212 induced with the hydroxyl radicals 216 is dispersed to the one or more plants 104 via the disperser 222 (e.g., as illustrated in FIG. 2).

In a step 612, at least a portion of the hydroxyl radical-induced ozonated water is circulated via a fluid flow loop. In one embodiment, the at least the portion of the hydroxyl radical-induced ozonated water is circulated via the fluid flow loop 400 from the retention tank 218 to the venturi assembly 208 (e.g., as illustrated in FIGS. 2 and 4).

It is noted herein the method 600 is not limited to the steps provided. For example, the method 600 may instead include more or fewer steps. By way of another example, the method 600 may perform the steps in an order other than provided. Therefore, the above description should not be interpreted as a limitation on the scope of the present disclosure, but merely an illustration.

Although embodiments of the present disclosure are directed to the advanced oxidation subsystem 206 including the UV reactor 214, it is noted herein the advanced oxidation subsystem 206 may be designed to bypass the UV reactor 214 in select situations where the hydroxyl radicals 216 may not be necessary. For example, the advanced ozogation apparatus 102 may be configured to provide a wash function with cold water, a rinse and sanitize process with the ozonated water 212, a sanitize with gaseous ozone process, and/or a plant 104 dispersion process.

Although embodiments of the present disclosure are directed to water as a carrier fluid for the gaseous ozone (e.g., resulting in ozonated water and hydroxyl radical-induced ozonated water), it is noted herein the advanced ozogation apparatus and process as described herein may implement any fluid as a carrier fluid for the gaseous ozone 202 in which the gaseous ozone 202 is at least partially soluble (e.g., resulting in an ozonated carrier fluid and a hydroxyl radical-induced ozonated carrier fluid). Therefore, the above description should not be interpreted as a limitation on the scope of the present disclosure, but merely an illustration.

Advantages of the present disclosure include an advanced ozogation apparatus and process. Advantages of the present disclosure also include generating ozone, generating ozonated water, and increasing the reactivity of the ozonated water by inducing hydroxyl radicals. Advantages of the present disclosure also include dispersing the ozonated water on plants at a select oxidation-reduction-potential (ORP) level.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device-detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively, or in addition, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively, or in addition, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C, C++, python, Ruby on Rails, Java, PHP, .NET, or Node.js programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, or the like; and a transmission type medium such as a digital and/or an analog communication medium (e.g., a fiber optic cable, a waveguide, a wired communications link, a wireless communication link (e.g., transmitter, receiver, transmission logic, reception logic, or the like), or the like).

Generally, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), or the like), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, or the like)), electrical circuitry forming a communications device (e.g., a modem, communications switch, optical-electrical equipment, or the like), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

Generally, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, or the like)), and/or electrical circuitry forming a communications device (e.g., a modem, communications switch, optical-electrical equipment, or the like). Those having skill in the art will recognize that the subject matter described herein may be implemented in an analog or digital fashion or some combination thereof.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, or the like), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although a user is described herein as a single figure, those skilled in the art will appreciate that the user may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” or the like. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” or the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, or the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, or the like). In those instances where a convention analogous to “at least one of A, B, or C, or the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, or the like). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Although particular embodiments of this invention have been illustrated, it is apparent that various modifications and embodiments of the invention may be made by those skilled in the art without departing from the scope and spirit of the foregoing disclosure. It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Accordingly, the scope of the invention should be limited only by the claims appended hereto.

What is claimed:

1. An advanced ozogation apparatus, comprising:
an ozone generator subsystem configured to generate ozone from ambient air;
an advanced oxidation subsystem, comprising:
a venturi assembly configured to generate ozonated water by combining water and the generated gaseous ozone;
an ultraviolet reactor configured to induce hydroxyl radicals within the ozonated water; and
a retention tank configured to store the hydroxyl radical-induced ozonated water, wherein the retention tank is configured to receive the hydroxyl radical-induced ozonated water via a mass transfer subsystem; and
a disperser configured to disperse the hydroxyl radical-induced ozonated water to one or more plants, wherein the retention tank is configured to output the hydroxyl radical-induced ozonated water to the disperser.

2. The apparatus of claim 1, wherein the mass transfer subsystem comprises:
a manifold configured to receive the hydroxyl radical-induced ozonated water from the ultraviolet reactor; and
at least one tube coupled to the manifold, wherein the at least one tube includes a plurality of holes.

3. The apparatus of claim 2, wherein the at least one tube is weighted and positioned at a bottom of a cavity defined within the retention tank.

4. The apparatus of claim 1, wherein the hydroxyl radical-induced ozonated water has an oxidation-reduction-potential (ORP) voltage of at least 750 millivolts (mV) at the one or more plants.

5. The apparatus of claim 1, wherein the water is stored in the retention tank, wherein the advanced oxidation subsystem further comprises a circulating pump configured to circulate the water from the retention tank to the venturi assembly.

6. The apparatus of claim 5, wherein the circulating pump is further configured to circulate at least a portion of the hydroxyl radical-induced ozonated water from the retention tank to the venturi assembly.

7. The apparatus of claim 1, wherein a temperature of the ozone generator subsystem is maintained via an air conditioner.

8. An advanced oxidation subsystem for an advanced ozogation apparatus, comprising:
an ultraviolet reactor configured to induce hydroxyl radicals within ozonated water generated from gaseous ozone and water; and
a retention tank configured to store the hydroxyl radical-induced ozonated water, wherein the retention tank is configured to receive the hydroxyl radical-induced ozonated water via a mass transfer subsystem,
wherein the hydroxyl radical-induced ozonated water is dispersed to one or more plants.

9. The subsystem of claim 8, wherein the mass transfer subsystem comprises:
a manifold configured to receive the hydroxyl radical-induced ozonated water from the ultraviolet reactor; and
at least one tube coupled to the manifold, wherein the at least one tube includes a plurality of holes.

10. The subsystem of claim 9, wherein the at least one tube is weighted and positioned at a bottom of a cavity defined within the retention tank.

11. The subsystem of claim 8, wherein the retention tank is configured to output the hydroxyl radical-induced ozonated water to a disperser configured to disperse the hydroxyl radical-induced ozonated water to the one or more plants.

12. The subsystem of claim 11, wherein the hydroxyl radical-induced ozonated water has an oxidation-reduction-potential (ORP) voltage of at least 750 millivolts (mV) at the one or more plants.

13. The subsystem of claim 8, wherein the ozonated water is generated by combining the generated gaseous ozone and the water via a venturi assembly.

14. The subsystem of claim 13, wherein the water is stored in the retention tank, wherein the water is circulated from the retention tank to the venturi assembly via a circulating pump.

15. The subsystem of claim 14, wherein at least a portion of the hydroxyl radical-induced ozonated water is circulated from the retention tank to the venturi assembly via the circulating pump.

16. The subsystem of claim 8, wherein the gaseous ozone is generated from ambient air via an ozone generator subsystem.

17. The subsystem of claim 8, wherein a temperature of the ozone generator subsystem is maintained via an air conditioner.

18. A method, comprising:
generating gaseous ozone from ambient air via an ozone generator;
generating ozonated water by combining water and the generated gaseous ozone;
inducing hydroxyl radicals within the ozonated water via an ultraviolet reactor; and
dispersing at least a portion of the hydroxyl-radical induced ozonated water to one or more plants via a disperser.

19. The method of claim 18, further comprising:
storing the water in a retention tank; and
circulating the water from the retention tank to the venturi assembly via a circulating pump.

20. The method of claim 19, further comprising:
storing the hydroxyl-radical induced ozonated water in the retention tank prior to the applying of the hydroxyl-radical induced ozonated water to the one or more plants, wherein the retention tank is configured to receive the hydroxyl radical-induced ozonated water via a mass transfer subsystem; and
circulating at least a portion of the hydroxyl radical-induced ozonated water from the retention tank to the venturi assembly via the circulating pump.
